(19) United States
(12) Patent Application Publication
(10) Pub. No.: US 2024/0322205 A1
(43) Pub. Date: Sep. 26, 2024

(54) METHOD FOR OPERATING A FUEL CELL SYSTEM, AND CONTROL DEVICE

(71) Applicant: Robert Bosch GmbH, Stuttgart (DE)

(72) Inventors: Helerson Kemmer, Vaihingen (DE); Matthias Rink, Herrenberg (DE)

(21) Appl. No.: 18/577,994

(22) PCT Filed: Jun. 30, 2022
(86) PCT No.: PCT/EP2022/068022

§ 371 Date: Jan. 9, 2024

(30) Foreign Application Priority Data
Jul. 12, 2021 (DE) 10 2021 207 337.9

(51) Int. Cl. H01M 8/0438; H01M 8/04223; H01M 8/04303; H01M 8/0432; H01M 8/04746

(52) U.S. Cl. CPC H01M 8/04417; H01M 8/04253; H01M 8/04303; H01M 8/04358; H01M 8/04768

(57) ABSTRACT

The invention relates to a method for operating a fuel cell system (1), comprising a fuel cell stack (2), which has a plurality of fuel cells and through which cooling channels extend, which are fed a coolant via a cooling circuit (3) by means of a coolant pump (4). According to the invention, in the event of a start under cold or freezing conditions the temperature of the fuel cells in the fuel cell stack (2) is measured indirectly by means of the pressure difference (Δp) of the coolant across the fuel cell stack (2) and the rotational speed (n) of the coolant pump (4) is controlled in accordance with the indirectly measured temperature.

The invention also relates to a control device for a fuel cell system (1).

### BACKGROUND

The invention relates to a method for operating a fuel cell system, in particular during a start under cold or freezing conditions. The method is therefore particularly suitable for operating fuel cell systems in mobile applications.

Furthermore, the invention relates to a control device which is set up to carry out steps of the method.

A fuel cell converts a fuel, for example hydrogen, and oxygen into electrical energy, heat and water. To increase performance, a plurality of number of fuel cells are usually connected to form a fuel cell stack and supplied with the reaction gases via supply channels running through the fuel cell stack. The heat generated during the electrochemical process in the fuel cells is dissipated with the aid of a cooling circuit and released into the environment via a cooler-usually the vehicle radiator in mobile applications. The coolant of the cooling circuit is pumped through the coolant supply channels running through the fuel cell stack with the aid of a coolant pump integrated into the cooling circuit. A directional control valve can be integrated into the cooling circuit to bypass the radiator. Bypassing the radiator can be advantageous when starting, for example. This is because the fuel cell stack should be heated up as quickly as possible when starting, especially at environmental temperatures below 0° C., in order to avoid water and/or ice accumulation, which could delay or even prevent starting. However, the risk of icing is only averted when the coolant has been safely heated above 0° C. before entering the fuel cell stack.

The heat generated in connection with the electrochemical reaction in the fuel cells can be used to warm up the coolant during a start under freezing conditions. Alternatively, the coolant can be heated externally. In both cases, however, the start process is prolonged. In addition, due to the constant cooling of the fuel cells below 0° C., measures must be taken to increase the ice tolerance of the fuel cells, for example by using ice buffers in the fuel cells and/or heaters in the fuel cell system.

During a start under freezing conditions, the coolant volume flow must be high enough to avoid local temperature peaks, so-called “hot spots”, and an excessive temperature difference between the inlet and outlet temperature of the coolant. At the same time, the coolant volume flow must be low enough to prevent an excessive temperature drop and thus icing when entering the fuel cell stack. The coolant volume flow is controlled via the pump rotational speed of the coolant pump. This is usually controlled depending on the coolant temperature at the inlet and outlet of the fuel cell stack. However, due to the high viscosity of the coolant, the change in coolant temperature during a start under freezing conditions has a large time lag compared to the temperature change in the fuel cells.

The present invention is therefore concerned with the task of specifying a method for operating a fuel cell stack in which, in the event of a start under cold or freezing conditions, the temperature in the fuel cell stack can be measured as quickly and reliably as possible in order to be able to adjust the rotational speed of a coolant pump and thus the coolant volume flow through the fuel cell stack as a function of the temperature.

In order to solve this problem, the method according to the disclosure is proposed. Advantageous further developments of the invention can be gathered from the dependent claims. A control device for carrying out the method is also specified.

### SUMMARY

A method is proposed for operating a fuel cell system comprising a fuel cell stack having a plurality of fuel cells through which cooling channels pass. With the method, the cooling channels are supplied with a coolant via a cooling circuit using a coolant pump. According to the invention, during a start under cold or freezing conditions, the temperature of the fuel cells in the fuel cell stack is measured indirectly via the pressure difference of the coolant across the fuel cell stack. The rotational speed of the coolant pump is controlled depending on the indirectly measured temperature.

The variable used to measure the temperature in the fuel cells is therefore no longer the temperature of the coolant at the inlet and outlet of the fuel cell stack, but the pressure of the coolant or the pressure difference of the coolant across the fuel cell stack. Since the viscosity of the coolant flowing through the cooling channels of the fuel cell stack changes with the temperature in the fuel cell stack, the temperature in the fuel cell stack can be deduced from the pressure difference between the pressure of the coolant at the inlet of the fuel cell stack and the pressure of the coolant at the outlet of the fuel cell stack.

Using the pressure difference as a variable for indirectly measuring the temperature in the fuel cells has the advantage that the pressure difference essentially runs in the opposite direction to the rise in temperature in the fuel cells, i.e. it decreases, and indeed without a time delay. The temperature can therefore be measured faster and more reliably.

In this way, the proposed method enables improved adjustment of the rotational speed of the coolant pump during a start under cold or freezing conditions. For example, the risk of icing due to an excessively high coolant volume flow can be reduced. The reduced risk of icing can in turn reduce the measures required to increase the ice tolerance of the fuel cells, thereby reducing costs. In addition, a fast start under freezing conditions can be realized as the coolant volume flow does not have to be reduced to avoid excessive temperature differences. Furthermore, leaks caused by temperature differences can be eliminated, thus increasing the service life of the fuel cell system.

Using the pressure difference as a variable for indirectly measuring the temperature change in the fuel cell stack also has the advantage that the pressure difference can be measured comparatively easily and inexpensively using simple pressure sensors.

It is therefore preferable to measure the pressure difference of the coolant across the fuel cell stack by means of several pressure sensors or by means of a differential pressure sensor to detect the pressure difference of the coolant at the inlet and outlet of the fuel cell stack. Pressure sensors or differential pressure sensors are significantly cheaper to purchase than volume flow sensors, for example. A first pressure sensor can be arranged at the inlet and a second pressure sensor at the outlet of the fuel cell stack. The pressure sensors can also be combined with a temperature sensor so that pressure and temperature sensors are used. As temperature sensors are usually already present, the number of sensors can be kept to a minimum in this way.

Furthermore, it is proposed that during the start under cold or freezing conditions, the rotational speed of the coolant pump be increased continuously or gradually in order to keep the pressure difference of the coolant across the fuel cell stack essentially constant or within a predefined range. Increasing the rotational speed of the coolant pump leads to rapid heating of the coolant and thus of the fuel cells. The pump rotational speed can be increased continuously or in steps or stages. The gradual increase has the advantage that the rotational speed of the pump increases less during the start under cold or freezing conditions and an excessively high rotational speed of the pump is avoided. In a first step, the rotational speed of the pump is increased until a predefined maximum pressure difference of 10 mbar, for example, can be measured. It then remains constant for a while, so that the pressure difference of the coolant across the fuel cell stack decreases again due to the heating of the coolant. If it reaches a predefined minimum pressure difference of 5 mbar, for example, the rotational speed of the pump is increased again in a second step until the pressure difference has reached the predefined maximum value again. This can be repeated until the coolant temperature has reached its target temperature and the start under cold or freezing conditions is complete. When the rotational speed of the pump is gradually increased, the pressure difference of the coolant across the fuel cell stack preferably exhibits a sawtooth-like curve within the predefined range.

If, on the other hand, the pressure difference of the coolant across the fuel cell stack shows an increasing curve and/or exceeds a predefined maximum value, the rotational speed of the coolant pump must be reduced. This is because a corresponding course of the pressure difference is a sign that the volume flow is too high, so that there is a risk of icing. This is because if the volume flow is too high, the coolant cools the fuel cells rather than heating them.

As an additional measure, it is therefore proposed that the rotational speed of the coolant pump be reduced during the start under cold or freezing conditions if the pressure difference of the coolant across the fuel cell stack shows an increasing curve and/or rises above a predefined maximum value. In this way, icing caused by the coolant volume flow can be reliably avoided.

According to another preferred operating strategy, the rotational speed of the coolant pump is kept constant during the start under cold or freezing conditions in order to reduce the pressure difference of the coolant across the fuel cell stack. This curve corresponds to normal heating of the fuel cells. This also reduces the risk of icing due to an excessively high coolant volume flow. If the pressure difference increases, this can also be counteracted by reducing the rotational speed of the coolant pump.

In a further development of the invention, it is proposed that a first threshold value be set which defines an initial minimum pressure difference of the coolant across the fuel cell stack and, in preparation for a start under cold or freezing conditions, the rotational speed of the coolant pump is increased until the threshold value is reached. This measure ensures that a usable measuring range is available during the start under cold or freezing conditions. This is because the temperature of the fuel cells rises quickly during a start under cold or freezing conditions, so that the temperature curve and thus the pressure difference curve are very steep in each case. The initial pressure difference must therefore be sufficiently high. The rotational speed of the coolant pump is therefore increased until the threshold value is reached. To ensure that the high volume flow resulting from the high rotational speed of the pump does not cause icing in the inlet area of the fuel cells, the rotational speed should not be set too high. The threshold value should therefore be reached in preparation for the start under cold or freezing conditions, but not significantly exceeded. In this way, icing is counteracted on the one hand, and on the other hand a sufficiently high coolant volume flow is achieved, which prevents the formation of “hot spots”.

The first threshold value can be 50 mbar, for example. In this case, the coolant is circulated in such a way that the heat generated is well distributed in the fuel cells. At the same time, the coolant flow is so small that icing in the inlet area of the fuel cells is avoided.

Furthermore, two additional threshold values are preferably defined, which define a range for a pressure difference of the coolant across the fuel cell stack to be achieved during the start under cold or freezing conditions. This means that at the end of the start under cold or freezing conditions, a pressure difference should be reached that lies within a previously defined range, which is limited at the bottom by a second threshold value and at the top by a third threshold value. The second threshold value, which can be 5 mbar, for example, ensures that the coolant volume flow is sufficiently high to circulate the coolant. The third threshold value, which lies above this and can be 15 mbar, for example, represents a reference value which—as described below-enables the first threshold value to be adapted. The same applies to the second threshold value.

According to a preferred embodiment of the invention, the first threshold value is raised or lowered if, at the end of the start under cold or freezing conditions, the pressure difference of the coolant across the fuel cell stack is outside the range of the pressure difference to be reached. This means that the first threshold value is raised if it falls below the second threshold value and lowered if it exceeds the third threshold value in order to enter the predefined range. This means that the first threshold value is adapted accordingly. The adaptation enables optimum adjustment of the initial rotational speed of the coolant pump and thus the coolant volume flow through the fuel cell stack as a function of the pressure difference of the coolant across the fuel cell stack at the end of the start under cold or freezing conditions and thus as a function of the temperature.

Due to the highly temperature-dependent viscosity of the coolant or the resulting large variation range of the pressure difference, the first threshold value can be different for each initial temperature. A first threshold value is therefore preferably defined for each initial temperature. This can then be stored in a control device. In addition, further dependencies can be taken into account when determining the first threshold value, for example the shutdown time, which determines whether the fuel cells must be fully or incompletely tempered.

Preferably, the course of the pressure difference is evaluated during the start under cold or freezing conditions or after the start under cold or freezing conditions and, in the case of a temporarily stagnating course, the third threshold value is lowered so that it moves closer to the second threshold value. A stagnating curve can be seen as a plateau in the graphical representation of the pressure curve. This indicates icing and a defrosting process. This can be seen as a sign that the initial rotational speed of the coolant pump was too high. By lowering the third threshold value, the first threshold value is adapted and thus the initial rotational speed of the coolant pump is lowered so that the risk of icing during a subsequent start under cold or freezing conditions is minimized.

Furthermore, preferably at least one threshold value, preferably all threshold values, is or are stored in a control device which is set up to carry out steps of the method. The method can thus be largely automated.

In addition, a control device for a fuel cell system is proposed, which is set up to carry out steps of the method according to the invention. In particular, the control device can be used to implement the various operating strategies described above. At least one threshold value can be stored in the control device for this purpose. The control device can also be used to evaluate the pressure difference of the coolant across the fuel cell stack. The control device receives the required measured values from the pressure sensors or the differential pressure sensor. Depending on the result of the evaluation, the control device can be used to control the coolant pump in order to increase, decrease or keep the rotational speed of the coolant pump constant.

### BRIEF DESCRIPTION OF THE DRAWINGS

The invention and its advantages are described in more detail below with reference to the accompanying drawings. Shown are:

FIG. 1 a schematic representation of a mobile fuel cell system which is suitable for carrying out a method according to the invention,

FIG. 2 a schematic representation of the media supply of a fuel cell stack for a fuel cell system,

FIG. 3 a diagram showing the curves of the pressure difference Δp of the coolant across the fuel cell stack, the coolant temperature at the inlet T_{On} and at the outlet T_{Off} of the fuel cell stack, the coolant volume flow Q, the rotational speed n of the coolant pump and the current I over time t,

FIG. 4 a block diagram showing the sequence of a first method according to the invention,

FIG. 5 a block diagram showing the sequence of a second method according to the invention,

FIG. 6 a diagram showing a preferred curve of the pressure difference Δp of the coolant across the fuel cell stack during a start under cold or freezing conditions,

FIGS. 7-9 in each case a block diagram showing the sequence of a method according to the invention,

FIG. 10 a diagram showing a further preferred curve of the pressure difference Δp of the coolant across the fuel cell stack including the rotational speed of the pump during a start under cold or freezing conditions, and

FIG. 11 a diagram showing temperature-dependent threshold values of the pressure difference.

### DETAILED DESCRIPTION

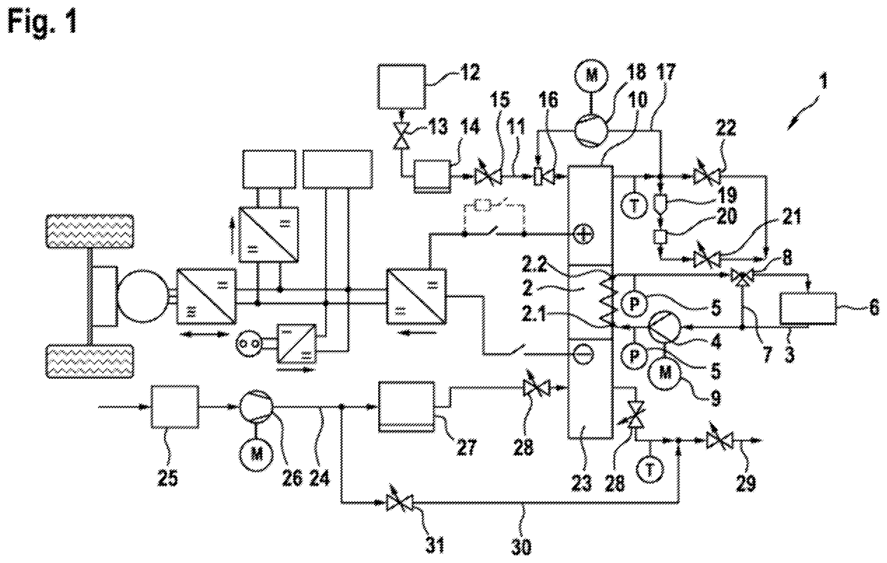

The fuel cell system 1 shown in FIG. 1 is used to generate electrical drive energy. For this purpose, the fuel cell system 1 comprises a fuel cell stack 2 with an anode 10 and a cathode 23. During operation of the system, the anode 10 is supplied with a fuel, for example hydrogen, via an anode path 11 and the cathode 23 is supplied with air as an oxygen supplier via a cathode path 24.

The fuel is stored in a tank 12, which can be shut off via a shut-off valve 13. A heat exchanger 14 for temperature control of the fuel and a pressure controller 15 for pressure control in the anode path 11 are arranged downstream of the shut-off valve 13. Furthermore, a jet pump 16 and a blower 18 arranged in a recirculation path 17 are provided, with the aid of which fuel emerging from the fuel cell stack 2 can be recirculated. As the escaping fuel can contain liquid water, it is fed to a water separator 19 before recirculation, which separates the liquid water from the gas and collects it in a container 20. When the container 20 is full, a drain valve 21 is opened and the container 20 is emptied. As the fuel accumulates with nitrogen over time, which diffuses from the cathode side to the anode side, the anode area is flushed from time to time. A purge valve 22 is opened for this purpose. The quantity drained via the purge valve is replaced by fresh fuel from the tank 12.

The air is extracted from the environment and fed to an air compressor 26 for compression via an air filter 25 arranged in the cathode path 24. As this heats the air, a heat exchanger 27 is also provided to cool the air. Shut-off valves 28 on the inlet and outlet side can be used to prevent air from entering the fuel cell stack 2 in the event of shutdown. The exhaust air leaving the fuel cell stack 2 is discharged back into the environment via an exhaust air path 29. In addition, a bypass path 30 with a bypass valve 31 arranged therein is provided to bypass the fuel cell stack 2.

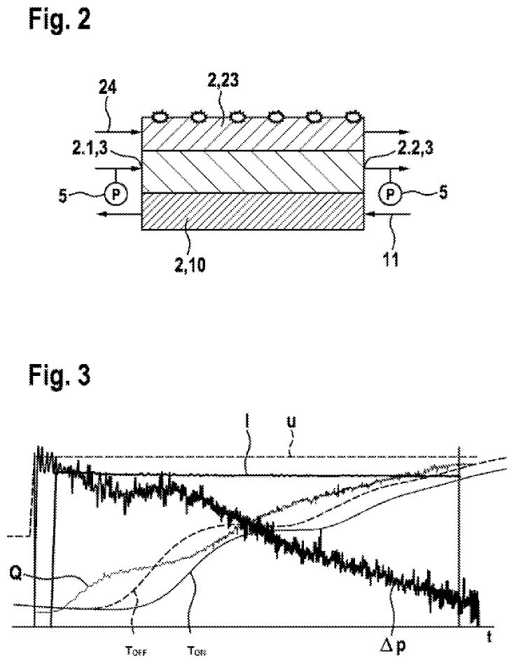

The operation of fuel cell stack 2 generates heat as well as electrical energy. The fuel cell stack 2 is therefore connected to a cooling circuit 3 with an integrated coolant pump 4. The circulating coolant transfers the absorbed heat to a radiator 6, wherein it can in particular be the vehicle's main radiator. To bypass the cooler 6, a cooler bypass 7 is provided, which is opened via a directional control valve 8. A pressure sensor 5 is integrated into the cooling circuit 3 in the area of an inlet 2.1 into the fuel cell stack 2 and in the area of an outlet 2.2 from the fuel cell stack 2. These measure the pressure of the coolant in the area of inlet 2.1 and outlet 2.2, so that the pressure difference of the coolant across the fuel cell stack 2 can be measured using these measured values (see also FIG. 2). As an alternative to the two pressure sensors 5, a differential pressure sensor (not shown) can also be used.

As shown as an example in FIG. 3, the pressure difference Δp of the coolant across the fuel cell stack 2 decreases at a constant rotational speed n of the coolant pump 4 during a start under cold or freezing conditions. The curve runs in the opposite direction to the temperature of the coolant, as the viscosity of the coolant decreases as the temperature rises. FIG. 3 shows the curves of the coolant temperature T_{On} the area of input 2.1 and T_{Off} the area of output 2.2. At the same time, the coolant volume flow Q increases. The change in temperature can therefore be read indirectly from the volume flow Q or the pressure difference Δp of the coolant. The present invention makes use of this connection. Since the pressure difference Δp can be measured using simple pressure sensors (see pressure sensors 5 in FIGS. 1 and 2), which are also significantly cheaper than volume flow sensors, the invention focuses on the pressure difference Δp for indirect measurement of the temperature change in the fuel cell stack 2.

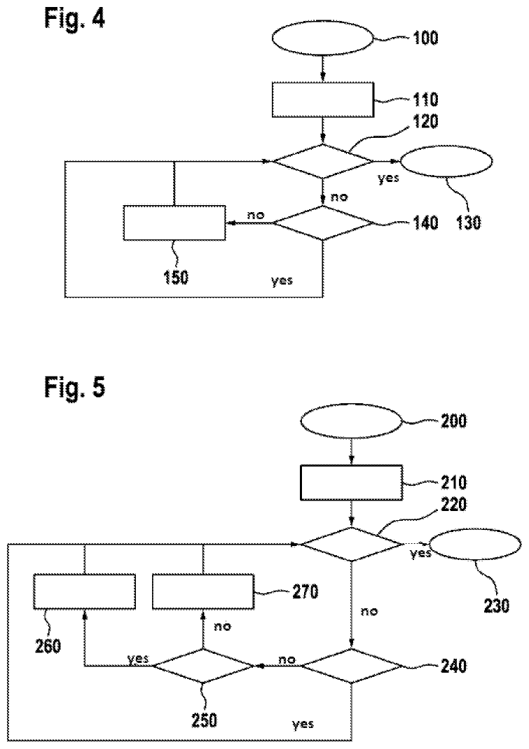

A first possible operating strategy according to the method according to the invention is shown in FIG. 4. At the beginning of a start under cold or freezing conditions (step 100), the coolant pump 4 is switched on first (step 110). It is then checked (step 120) whether the coolant inlet temperature T_{On} is above 0° C. If this is the case (“yes”), the method can already be ended (step 130). If this is not the case (“no”), the pressure difference Δp of the coolant across the fuel cell stack 2 is determined (step 140) and it is checked whether the pressure difference Δp decreases, i.e. whether the fuel cells heat up. If this is the case (“yes”), the inlet temperature T_{On} is measured again, which means that step 120 and step 130 or step 140 are repeated. If this is not the case (“no”), the rotational speed of the pump n is reduced before repeating these steps (step 150).

A modified operating strategy is shown in FIG. 5. Steps 200 to 230 correspond to steps 100 to 130. In step 240, the pressure difference Δp of the coolant across the fuel cell stack 2 is also determined and subjected to an evaluation. However, the system checks whether the pressure difference Δp is constant. If this is the case (“yes”), step 220 and step 230 or step 240 are repeated, depending on the measured temperature T_{On}. If this is not the case (“no”), step 250 checks whether the pressure difference Δp decreases. If this is the case (“yes”), the rotational speed of the pump n is increased (step 260). If this is not the case (“no”), the rotational speed of the pump n is reduced (step 270). Steps 220 and 230 or—depending on the measured temperature T_{On}—steps 220, 240 and 250 are then repeated.

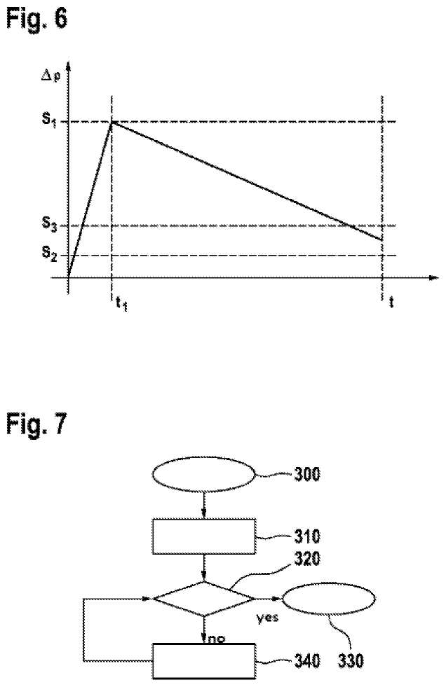

FIG. 6 shows a preferred curve of the pressure difference Δp of the coolant across the fuel cell stack 2 during a start under cold or freezing conditions, wherein the actual start under cold or freezing conditions does not begin until the moment ti. This is preceded by a phase in which the start under cold or freezing conditions is prepared. In this preparatory phase, the pressure difference Δp is brought to an initial value that corresponds to a minimum value, namely a threshold value S1. During the subsequent start under cold or freezing conditions, the pressure difference Δp is then brought to a target value that lies within a range defined by the threshold values S2 and S3. By setting the threshold values S1 to S3, an excessively high volume flow and thus icing is prevented. On the other hand, a volume flow is guaranteed that ensures sufficient circulation of the coolant.

A possible operating strategy in the preparation phase is shown as an example in FIG. 7. At the start of the preparation phase (step 300), the coolant pump 4 is first switched on (step 310). The pressure difference Δp is then determined in step 320 and checked to see whether it has reached the threshold value S1. If this is the case (“yes”), the preparation phase can be ended and the start under cold or freezing conditions can be initiated (step 330). If this is not the case (“no”), the rotational speed of the pump n must be increased (step 340).

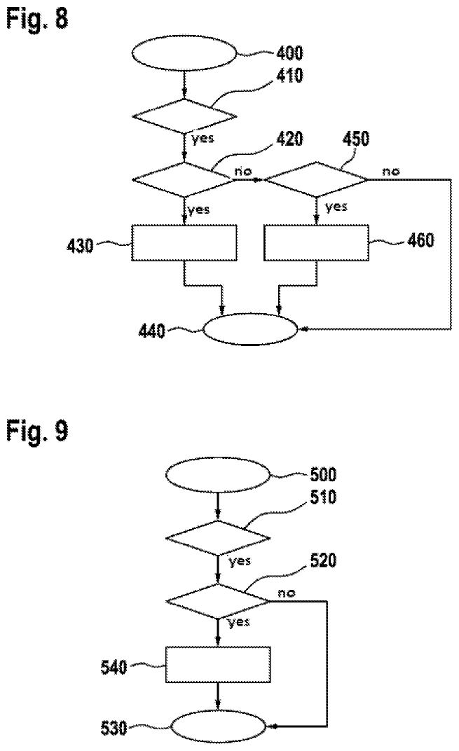

FIG. 8 shows another possible operating strategy in which the initial rotational speed of the pump n is adapted depending on the temperature. According to the invention, the temperature is measured indirectly via the pressure difference Δp of the coolant across the fuel cell stack 2. When adaptation is initiated (step 400), the system first checks whether a start under cold or freezing conditions has already been performed and ended (step 410). Only then will the information required for adaptation be available. It is then checked whether the pressure difference Δp at the end of the start under cold or freezing conditions was below the threshold value S2 (step 420). If the result of the check is positive (“yes”), the threshold value S1 is increased in step 430 and the adaptation is completed (step 440). If the result of the check is negative (“no”), the system checks whether the pressure difference Δp at the end of the start under cold or freezing conditions was above the threshold value S3 (step 450). If this is not the case (“no”), no adaptation needs to be made, so that the method can be ended with step 440. However, if the threshold value S3 has been exceeded (“yes”), the threshold value S1 must be lowered (460). Only then can the adaptation be completed (step 440).

Another way of adapting the initial rotational speed of the pump n by evaluating the course of the pressure difference Δp of the coolant across the fuel cell stack 2 is shown in FIG. 9. This method makes use of the fact that a temporarily stagnant course indicates icing. The stagnating course is recognizable as a plateau in an otherwise declining curve (see FIG. 3). When the adaptation is initiated (step 500), the method first checks whether a start under cold or freezing conditions has already been performed and completed (step 510). Only then will the information required for adaptation be available. It is then checked whether the pressure difference Δp of the coolant shows a plateau (step 520). If this is not the case (“no”), no adaptation is required and the method can be ended (step 530). However, if the result of the test is positive (“yes”), the threshold value S3 is lowered in step 540 and the adaptation is ended in the subsequent step 530.

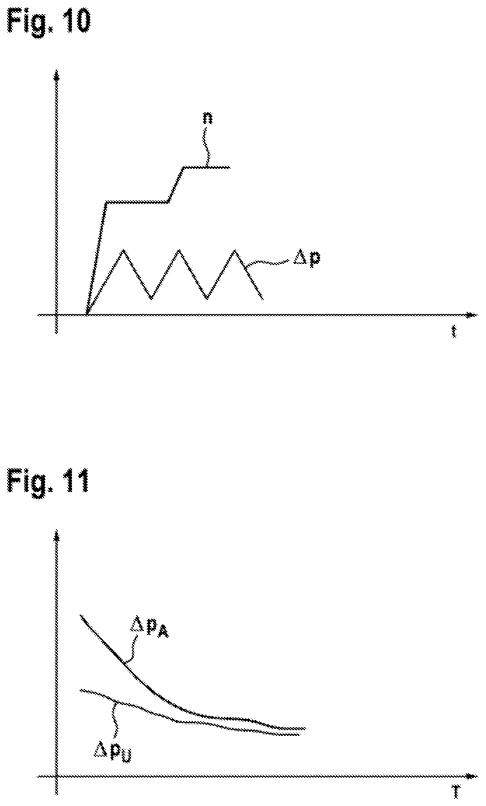

To avoid an initially very high rotational speed of the pump n, an operating strategy can also be selected that does not provide for a continuous increase in the rotational speed of the pump n, but rather a gradual or step-by-step increase, as shown as an example in FIG. 10. The pressure difference Δp also increases with each gradual increase in rotational speed n. During the time in which the rotational speed n is kept constant, the pressure difference Δp then decreases again. In this way, the pressure difference Δp can be kept within a certain range and exhibits the sawtooth-like curve shown in FIG. 10. As shown as an example in FIG. 11, the range can be limited by a lower value (Δp_{U}) and an upper value (Δp_{A}), which vary depending on the temperature.

1. A method for operating a fuel cell system (1), comprising a fuel cell stack (2) which has a plurality of fuel cells and through which cooling channels extend, which are fed a coolant via a cooling circuit (3) by means of a coolant pump (4),
wherein, in the event of a start under cold or freezing conditions the temperature of the fuel cells in the fuel cell stack (2) is measured indirectly by means of the pressure difference (Δp) of the coolant across the fuel cell stack (2) and the rotational speed (n) of the coolant pump (4) is controlled in accordance with the indirectly measured temperature.

2. The method according to claim 1,
wherein the pressure (p1) of the coolant at the inlet (2.1) and at the outlet (2.2) of the fuel cell stack (2) is measured with the aid of several pressure sensors (5) or with the aid of a differential pressure sensor to detect the pressure difference (Δp) of the coolant across the fuel cell stack (2).

3. The method according to claim 1,
wherein during the start under cold or freezing conditions, the rotational speed (n) of the coolant pump (4) is increased continuously or gradually to keep the pressure difference (Δp) of the coolant across the fuel cell stack (2) essentially constant or within a predefined range.

4. The method according to claim 1,
wherein the rotational speed (n) of the coolant pump (4) is kept constant during the start under cold or freezing conditions to reduce the pressure difference (Δp) of the coolant across the fuel cell stack (2).

5. The method according to claim 1,
wherein during the start under cold or freezing conditions, the rotational speed (n) of the coolant pump (4) is reduced if the pressure difference (Δp) of the coolant across the fuel cell stack (2) shows an increasing curve and/or rises above a predefined maximum value.

6. The method according to claim 1,
wherein a first threshold value (S1) is set, which defines an initial minimum pressure difference of the coolant across the fuel cell stack (2), and in preparation for a start under cold or freezing conditions, the rotational speed (n) of the coolant pump (4) is increased until the threshold value (S1) is reached.

7. The method according to claim 6,
wherein two further threshold values (S2, S3) are defined, which define a range for a pressure difference of the coolant across the fuel cell stack (2) to be achieved during the start under cold or freezing conditions, wherein the further threshold values (S2, S3) preferably lie below the first threshold value (S1).

8. The method according to claim 6,
wherein the first threshold value (S1) is raised or lowered if, at the end of the start under cold or freezing conditions, the pressure difference (Δp) of the coolant across the fuel cell stack (2) is outside the range of the pressure difference (Δp) to be reached.

9. The method according to claim 7,
wherein the course of the pressure difference is evaluated during the start under cold or freezing conditions or after a start under cold or freezing conditions and, in the event of a temporarily stagnating course, the third threshold value (S3) is lowered so that it moves closer to the second threshold value (S2).

10. The method according to claim 6,
wherein all threshold values (S1, S2, S3) are stored in a control device which is configured to carry out steps of the method.

11. A control device for a fuel cell system (1), that includes a fuel cell stack (2) which has a plurality of fuel cells and through which cooling channels extend, and which are fed a coolant via a cooling circuit (3) by means of a coolant pump (4), the control device comprising a processor configured to:
in the event of a start under cold or freezing conditions, measure the temperature of the fuel cells in the fuel cell stack (2) indirectly by means of the pressure difference (Δp) of the coolant across the fuel cell stack (2); and
control the rotational speed (n) of the coolant pump (4) in accordance with the indirectly measured temperature.
